(19) United States
(12) Patent Application Publication
(10) Pub. No.: US 2006/0218300 A1
(43) Pub. Date: Sep. 28, 2006

(54) Method and apparatus for programmable network router and switch

(75) Inventors: Satoshi Yoshizawa, Saratoga, CA (US); Kenichi Otsuki, Santa Clara, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/443,679

(22) Filed: May 30, 2006

Related U.S. Application Data
(63) Continuation of application No. 09/972,290, filed on Oct. 4, 2001.

(51) Int. Cl. G06F 15/173

(52) U.S. Cl. 709/238

(57) ABSTRACT

A system is described which enables provision of information to a stored program operating on a computer coupled to the network. A device connected to the network includes input ports for receiving information and output ports for providing the received information to a destination. The computer is coupled to receive information from the output port, which information is addressed to the computer. Within the device a flow control table holds entries which include source addresses representative of at least one source of information arriving at the device input ports, destination addresses representative of at least one of the destinations to which the arriving information is to be sent from an output port. The table entries also include action information for each address, and the action information can take the form of a program reference. When the information is received by the computer it can use the received information in execution of the stored program.

### CROSS-REFERENCE TO RELATED APPLICATION(S)

This is a continuation of U.S. patent application Ser. No. 09/972,290, filed Oct. 4, 2001.

### BACKGROUND OF THE INVENTION

This invention relates to programmable network routers and switches, systems for controlling traffic in a network, and in particular to a router or a switching system within which data processing capability is integrated, and methods for programming such a device.

The advent of the internet has made communications networks, and their use throughout the world, commonplace. These communications networks now carry data, voice, and video, necessitating ever greater bandwidths and the need for additional flexibility in operation. The technology for internet protocol network systems (herein “IP”) is a relatively recently developed communications technology designed to overcome constraints associated with traditional networks. IP technology can be used to transmit data, voice, and video, as well as any other type of data, on almost any type of network. Before the advent of IP, most networks were based on the type of data to be transported. Thus, public switched telephone networks and high speed digital transmission facilities were primarily designed and used for transporting information sensitive to delay, such as voice or video. In contrast, many packet-based networks were developed for data information which could tolerate delay. Users then adopted network technology to provide the necessary capability for their particular application, but the result was that many organizations supported multiple different types of networks.

Conventional IP network systems employ packets of data, each containing many bytes. The packets can be transported and switched at relatively high rates, for example, hundreds of megabits per second. Each IP packet includes a header portion, typically of 20 bytes (in version 4), and a “payload” portion. The payload portion can be of arbitrary size, but less than a maximum length. The packet switching employed in such networks forwards a particular packet arriving on an input line to a desired output line, or to a desired address, based on the contents of a header in the packet. To achieve this, the system examines the header of the packet to determine the desired address to which that packet is to be forwarded, then the system sends the packet on toward its destination. If fixed-length packets are used, relatively simple hardware can perform switching, for example, in ATM applications.

The header of an IP packet provides data for many different functions, including virtual path identification, virtual channel identification, payload type, error control, and other features. The use of packets enables packets transporting data, voice and video to be intermixed. Thus, variations in packet type may impact the latency of other packet types.

An IP device, commonly known as a router, is usually connected to receive information over many different incoming lines, and switch that information to many different outgoing lines. As a result, the IP packets arriving at the router are mixed with each other, that is, packets from each line are intermixed with packets from other lines. Packets from the individual connections, however, will be forwarded from router to router in accordance with their headers. In conventional routers, individual packets are routed from an input line to an output line depending upon the information held in the packet header.

Recently more networks have the added capability of programmability. In a programmable network the packets of data carry within them a program or a program reference that is to be executed at the network device as the packet is processed there. One approach to providing this processing capability is commonly known as an “active network.” In this approach, every packet carries with it a program (or a pointer or reference to a program) that is executed at the network device when the packet reaches that device. By writing a program to control some aspect of the operation at the network node, the node can be controlled in accordance with the information in the packet. A significant disadvantage of active networks occurs when packets are fragmented as they pass through the network. When packet fragmentation occurs, any data encapsulated in a packet that has not yet reached that node causes difficulty in preserving the state of the program at the network node. Such preservation cannot be achieved by a simple program reference, but instead requires reference to the specific execution instance of the program, and this is not known at the source of the data. DARPA is an example of an active network. It is described in Tennenhouse, D. L., et al., “Towards an Active Network Architecture,” SPIE Computer Communication Review, Vol. 26, No. 2 (April 1996); and Tennenhouse, D. L., et al, “A Survey of Active Network Research,” IEEE Communications Magazine, Vol. 35, No. 1 (January 1997), pp. 80-86.

Another approach is known as a “programmable network.” In a programmable network, resources of the network devices are abstracted and made controllable by software. The software interacts with the network devices through a set of standardized application programming interfaces. Of particular current interest is that by extracting resources related to the quality of service, such as those of queues, and making them available to be controlled through the APIs, one can manipulate the quality of service settings from the controller software. In addition, the standardized APIs permit easier and faster development of new network services. Programmable networks are described further in Lazar, A., “Programming Telecommunication Networks,” IEEE Network (September/October 1997), pp. 8-18; and Biswas, J., et al., “The IEEE P1520 Standards Initiative for Programmable Network Interfaces,” IEEE Communications, Special Issue on Programmable Networks, Vol. 36, No. 10 (October 1998), pp. 64-70.

### BRIEF SUMMARY OF THE INVENTION

We have developed a network device or system for providing information to a stored program operating on a computer coupled to a network. The invention provides a technique for supplying even fragmented packets belonging to the same flow into the same instance of an executing program. It does not delay other packets that are not designated to be processed by programs, and it does not degrade the quality of service for other packets. In our invention the network device or system preferably includes input ports for receiving information from a source, and output ports for providing the information received from the source to a destination. The computer is connected to receive information from an output port which provides to it information addressed to the computer.

A flow control table is stored within the network device and maintains entries. The entries include source addresses representative of the source for information arriving at the input port; destination addresses representative of the destinations to which the arriving information is to be sent from the output port, and action information for each address. Importantly, the action information in the flow control table includes at least one program reference. The computer receives information addressed to it from the output port and uses the received information in execution of the stored program.

### BRIEF DESCRIPTION OF THE DRAWINGS

FIG. 1 is a schematic representation of a typical network video delivery service system employing routers;

FIG. 2 is a block diagram illustrating an exemplary router configuration;

FIG. 3 is an example of a flow control table; and

FIG. 4 is a flow chart illustrating a method of updating the flow control table.

### DETAILED DESCRIPTION OF THE INVENTION

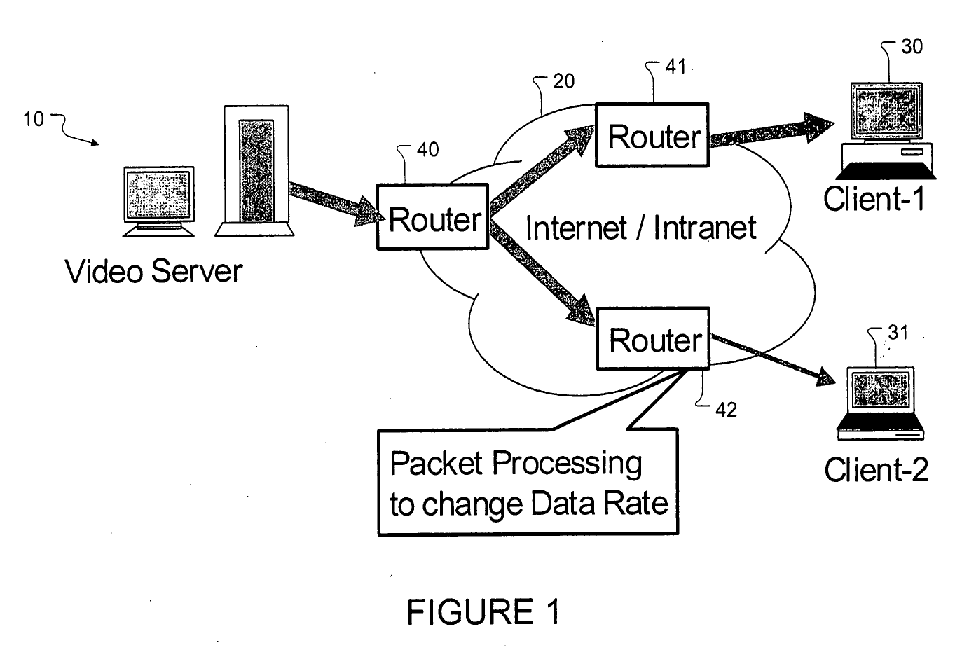

FIG. 1 is a diagram illustrating a typical example of a network, and this example will be used to illustrate a technique by which the resolution of video may be altered by the switch or router to provide each client with the best quality video possible. In the system shown in FIG. 1, video programs are transmitted from a video server 10 over a network 20 to a variety of clients 30, 31. The network includes routers 40, 41 and 42 which are used to switch the data received from the video server 10 through the network 20 and ultimately to the clients 30 and 31.

In this video delivery service system, a video program can be transmitted from the video server 10 to the various clients 30, 31 with different levels of quality. In particular, the data may be processed at a network node, for example router 42, to change the resolution of the video stream or data rate. In this manner, each of clients 30 and 31 can receive the best quality video, depending on its processing and/or packet receiving capability. In addition, the user of each client can choose the quality of video that he would like to receive, and the quality of video delivered to each client 30, 31 can be changed at any time depending upon the extent of traffic on the network, the user's choice, or other factors.

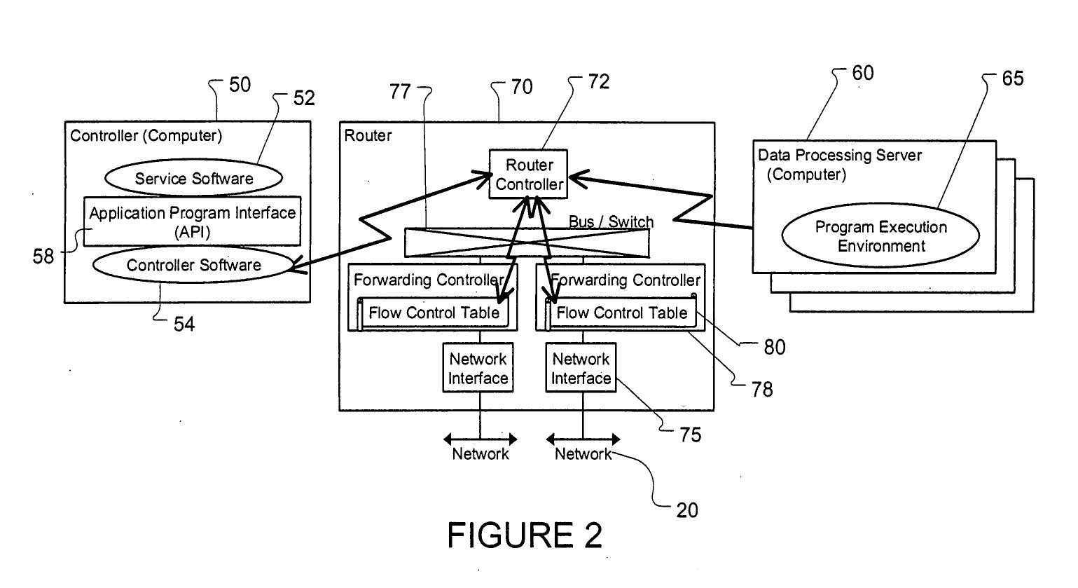

FIG. 2 is a block diagram illustrating a typical configuration for a network device such as a router or switch employed in implementing our invention. As shown, the system consists of a controller or computer 50, a data processing server 60 and a router 70. Controller 50 includes service software 52 and controller software 54 which communicate via an application program interface (API) 58. Controller 50 is coupled to the router controller 72. Also coupled to router controller 72 is data processing server 60. The server typically consists of a computer and has an environment for executing program 65.

Router 70 is coupled to network 20 via network interfaces 75. Interfaces 75 allow information to be supplied to router 70 and received from router 70 on the network. A typical function of router 70 is to accept packets of information from network 20, then decode the header information and forward the payload portion (possibly with a new header) on to the desired client or downstream router.

Router controller 72 interfaces via a bus or switch 77 with forwarding controllers 78. The forwarding controllers 78 include a flow control table 80 which will be described below.

Router 70 can be connected to multiple numbers of networks 20. The forwarding controllers 78 control the output path for the data depending upon the settings placed in the flow control table 80. Flow control table 80 is maintained by the router controller 72, which itself is controlled by controller 50. Controller 50 is typically a computer residing separately from the router, but coupled to it. For the embodiment shown in FIG. 2, suitable for implementation in programmable networks environments, a standardized API is provided in the controller, with service software executing on top of that API. Importantly, for the depicted embodiment the router is associated with a data processing server 60 where data processing can be executed. This allows information from the network to be forwarded on to the data processing server for execution. In another embodiment of the invention, the data processing server is incorporated within the router itself (or vice versa). Of course, controller 50 also may be incorporated within the data processing server 60 and/or the router 70 in any combination of controller 50, server 60, and router 70.

In operation, packets arriving on network 20 are connected through the network interfaces 75 to the forwarding controllers 78. These forwarding controllers, using header information from the packets, perform appropriate operations on the packets, including removal of the header information and replacement of that information with new address information, or other well know operations.

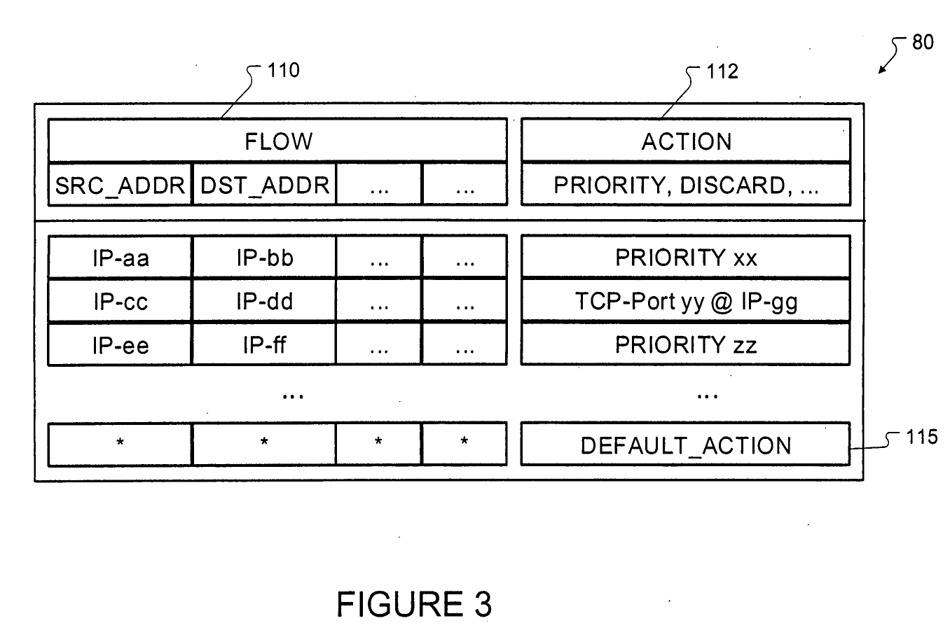

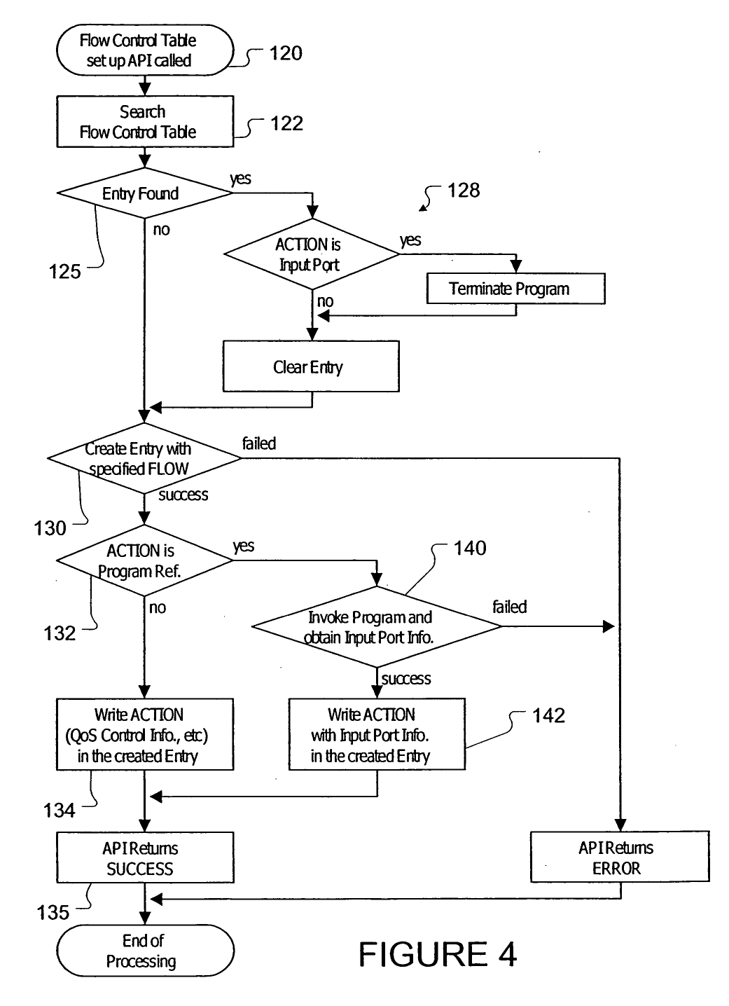

The forwarding controllers 78 control the packets in part based upon the settings of the flow control table 80. The flow control table is maintained by the router controller 50, which itself receives information from other sources. It should be understood that controller 50 can control more than a single router, and as is well known, each router can have many network interfaces for receiving and transmitting information to and from the network. The use of the APIs in the controller 50 allows application software to be executed elsewhere and easily communicate with the programmable router 70. The operation of the system shown in FIG. 2 is explained with respect to FIGS. 3-4.

FIG. 3 is a more detailed illustration of a flow control table 80. When a packet arrives over network 20 to the network interface 75 the forwarding controller 78 searches through flow control table 80 to determine whether the header information for the incoming packet is registered in the table. This is done by matching the entries in the flow portion 110 of the table 80 with respective fields in the packet. For example, the flow 110 portion of table 80 includes columns for source address (SRC_ADDR) and destination address (DST_ADDR). The packet received at the router consists of header information and payload information. Because the flow portion of the table typically will be concerned only with the header information, the payload information is not used.

After checking the incoming packet against the flow table portion 110, an appropriate corresponding action, shown in the “Action” portion 112 will be carried out. For example, incoming packets from source IP-aa which are to be sent to address IP-bb will be forwarded with a priority of “xx” (which may include a bandwidth specification). In a similar manner, packets from source IP-ee which are addressed to location IP-ff will be dispatched with priority zz. Packets whose header information does not correspond to entries in the flow table will be handled in accordance with a default action, as illustrated by row 115. This default action typically is set by a longer term “static” allocation of resources. The default action can also be set to handle packets without any priority setting, so that the packets are forwarded on a “best efforts” basis. Actions stored in flow control table 96 can be modified by hardware, or software processing.

According to this invention the action field 112 may include as an entry the input port of a program under execution. In such a situation, the packet is then forwarded to that input port by adding appropriate packet header information to the packet. In such a circumstance, the field may include a reference to a program, for example, a URL, an object ID, or other reference. This may be achieved, using the embodiment of FIG. 2, by having the API 58 set up the flow control table. When the API to set up the flow control table is called, if the “Action” field is a program reference, then the program is invoked, and its input port is prepared. The reference to the input port of the invoked program is then set into the Action field of the new entry in the flow control table. The default action, as illustrated by row 115 of flow control table 80, can also be a program reference.

As a result, a software program to process packet flow, or perform other operations, may be invoked when the API is called, and the “hook” for supplying the invoked program with the data packets is recorded into flow control table 80. To achieve this, an “If, Then” pair may be employed.

The If portion of the argument will have information for determining the origin flow of the incoming packet. This can be achieved by specifying the combination of source address, source port, destination address, destination port, and protocol ID. In another approach it can be achieved by specifying the MPLS label for systems in which MPLS switching is performed. Furthermore, it can be used to control quality of service by specifying the Diffserve Code Points (DSCP value) within the Diffserve core network.

On the other hand, the Then portion specifies how to handle the incoming packets to fulfill the desired quality of service requirements. This is typically done by specifying the output queues to which the packets are to be sent, for example by choosing among queues with different characteristics such as length, priority, etc.

According to this invention the Then part of the API is allowed to have reference to a software program, such as a file name, a URL, an object ID, etc. Furthermore, other parameters (arguments) to be supplied to the software program can also be specified, along with the program reference. Listing A below is an example of an API.

Listing A

| | |
|---|---|
| struct | END_POINT { |

| | | | |
|---|---|---|---|
| IP_ADDRESS | ipaddr ; | /* may be range of addresses | */ |
| unsigned short | port ; | /* may be range of ports | */ |
| ... | | | |

} ;

| | |
|---|---|
| struct | FLOW { |

| | |
|---|---|
| struct END_POINT | source ; |
| struct END_POINT | destination ; |
| ... | |
| octet | protocol_id ; |
| ... | |

} ;

| | |
|---|---|
| struct | QOS_SETTING { |

| ... | |
|---|---|
| /* Specify priority, mode (DISCARD, etc), etc. | */ |

| | |
|---|---|
| ..../* Could be a list, relating values of particular packet field to an ACTION | */ |

...

} ;

| | |
|---|---|
| struct | PROGRAM_INFO { |

| | | |
|---|---|---|
| int | agrv ; | /* Number of arguments, including program reference */ |
| char | *argc[ ] ; | /* Array of strings: program reference & arguments */ |

} ;

| | |
|---|---|
| union | ACTION { |

| | |
|---|---|
| struct QOS_SETTING | qos_settings ; |
| struct PROGRAM_INFO | program_infos ; |

} ;

| | |
|---|---|
| boolean | Set_Action (in FLOW target_flow, in ACTION new_action) ; |

When this API is called in a network element, and if the “Then” part of the API is a program reference, the referred program is to be invoked along with the given parameters, if any. The caller of the API will typically be a service application program or other software residing in a server owned by the service provider. The remote call can be accomplished by means of Common Object Request Broker Architecture (CORBA) facilities, or a Remote Procedure Call (RPC). The caller, that is the service application, then decides on which network elements it should call using this API, for example by obtaining routing path information from a network management server or some other controlling policy server.

If the invocation of the preferred program is successful, the information needed to pass the packets to the program is obtained and recorded in the network elements along with the information given by the “If” part of the API. The invocation of the program thus involves the downloading of the program, typically from the service provider's file server to where the program is actually executed.

Of course, the physical location of where the program is to be invoked and executed is transparent to the API. To enhance performance, it is typically desirable to have the program invoked in a server physically near the network element, or if the network element has a data processing capability, then within the network element itself. The caller of the API or service application can decide on which network elements should call the API by obtaining the desired processing power availability (and possibly costs) at each network element along the routing path. Furthermore, policy servers may manage the processing power availability to each of the service providers at the specific network elements.

Alternatively, the processing facility does not need to be a single entity. A conglomeration of servers or a distributed processor can be employed. Furthermore, of course the called processor does not need to be a general purpose processor; it can be a specialized processor such as a digital signal processor or an image processor. Whatever the case, the caller is able to decide on which network element the API call should invoke the program, with prior knowledge of the special processing capabilities at various network elements. In addition, the caller can deliberately change the routing by means of MPLS or other well known techniques so that the flow goes through a network element equipped with the needed or appropriate special processing capability. One example is a special processor that efficiently handles video streams by changing bit rates resolution, encoding methods, etc.

Furthermore, the caller of the API may specify where (for example, the server location) to invoke and execute the program. This typically will occur in situations where the caller knows where the specialized processors reside in the network. In addition, the caller may also have its own server located near a network element and would like to utilize that server rather than some other server.

Listing B below is an example of an API where the location of the program invocation is specified. The location can be specified using an IP address of network servers or elements, while the former also may be specified using a URL. This API may be called without supplying the location information, for example, by setting a “null pointer” to this argument, in which case the program is invoked as if the API in Listing A were called.

Listing B

...
... /* cf. Listing A API Example (1) */
...

struct PROC_LOCATION {

...

| | |
|---|---|
| /* Specify location of the processor that the program is to be invoked. | */ |
| /* Could be IP address of a server; could further specify which CPU of a server. | */ |

...

} ;
struct QOS_SETTING {

...

| | |
|---|---|
| /* Specify priority, mode (DISCARD, etc), etc. | */ |

| | |
|---|---|
| ..../* Could be a list, relating values of particular packet field to an ACTION | */ |

...

} ;
struct PROGRAM_INFO {

| | | |
|---|---|---|
| int | agrv ; | /* Number of arguments, including program reference */ |
| char | *argc[ ] ; | /* Array of strings: program reference & arguments */ |
| struct PROC_LOCATION | location ; | |

} ;
union ACTION {

| | |
|---|---|
| struct QOS_SETTING | qos_settings ; |
| struct PROGRAM_INFO | program_infos ; |
| } ; | |

| | |
|---|---|
| boolean | Set_Action (in FLOW target_flow, in ACTION new_action) ; |

In addition the same API can be used to change the parameters of an already executed program. In such circumstances the API is called with the If part identical to the previous calls, but with different Then portions. The new parameters are to be passed to the already-executed program through its input port, for example, as a program control packet, thus changing the way the program works on the packet data that it processes.

In other embodiments of the invention, the invocation process of the program may pass through the network management system (NMS). Presently, NMSs only manage the network resources in the sense of carrying traffic. This invention provides the capability of allowing the NMS to manage the processing resources located within the network. For example, if the server is integrated to the network element itself and owned by the network provider, an authentication and accounting mechanism may be needed for third parties to use the server.

In another case the service provider does not need to use the NMS to manage the processing resources. The NMS, however, can provide authentication so that only the owner of the server can utilize that server. Alternatively, the NMS may provide accounting functions, recording all usage of the processing power by other service providers.

Each indication of the program by calling the API will create different instances (processes or tasks) even when the same program is specified, and each will be executed or terminated independent of the execution or termination of other programs. For flows that the invoked program perform some data processing, a quality of service setting for the next hop for the packet can be specified. This may be achieved using the same API with flow specification in the If part of the argument set so that it matches this flow. In such a case the flow control table will hold multiple actions in series in its action field. Similarly, the action field may have a series of program references to provide a pipeline of multiple program processing.

FIG. 4 is a flow chart illustrating in more detail the process for invoking a specific program when the flow control table API is called from the service software, and input port information is written into the flow control table 80. The process begins with step 120 in which the flow control table is called to set up an API. At step 122 the flow control table is searched for a corresponding entry to the information received on the network. If an entry is found which matches, the program is terminated and the entry cleared as shown by steps 128. On the other hand, if no entry is found, then at step 130 an entry is created with the specified information. Assuming the action field is not a program reference, this field is written into the created entry as shown by steps 132 and 134. Thus, the process is successfully completed as shown by step 135. On the other hand, if at step 132 it is determined that the action is a program reference, the program in invoked and the input port information is obtained at step 140. If this step is successful, then the action with the input port information is written into the created entry as shown by step 142, again resulting in success for the API.

As has been described, this invention can be adopted into routers or switches, especially those in which hardware assisted packet forwarding or quality of service control mechanisms are employed, and particularly where packet processing capability in the network is needed by an application. By inclusion of this invention into the standardization on the API for controlling network devices, the invention can be adopted into network services which are built upon the API. This provides widespread capability for use of the programmable features discussed above.

Although multiple embodiments have been described for the inventions herein, it should be understood that the specification is provided to describe specific examples of the invention. The scope of the invention can be determined from the appended claims.

What is claimed is:

1. In a system having a stored program executing on a computer coupled to a network, apparatus for enabling packets of information to be provided to a particular instance of the execution of the stored program, the apparatus comprising:
at least one input port for receiving packets of information from a source coupled to the network, at least some of which packets individually include a payload and a header having an address;
at least one output port for providing the packets from the source to the computer when a packet is addressed to the computer;
a flow control table for storing at least the headers of the packets of information, which header includes:
a source address representative of at least one source of the packet arriving at the input port;
a destination addresses indicative of at least one destination to which the packet is to be sent; and
action information for that packet, the action information including at least one reference to the stored program executing on the computer; and
wherein, when the action information in the flow control table so specifies, a packet with action information specifying an operation by the computer is forwarded to the computer, and that packet is used in execution of the stored program.

2. A system as in claim 1 wherein the action information includes default priority information used to control information which does not otherwise have an entry in the flow control table.

3. A system as in claim 2 wherein the system includes a switch for switching information and a controller coupled to the switch for storing the flow control table and controlling the switch in response thereto.

4. A system as in claim 3 wherein the switch comprises a router and the flow control table is maintained by a controller in the router.

5. A system as in claim 4 wherein the router controller is itself controlled by a computer.

6. A system as in claim 3 wherein the router controller manages the flow control table using an applications program interface.

7. A system as in claim 2 wherein the system comprises an IP router.

8. A system as in claim 2 wherein the system comprises an IP switch.

9. A system as in claim 1 wherein the action information in flow control table is established by an applications program interface which communicates with the system.

10. A system as in claim 9 wherein the applications program interface employs an argument which includes an “if” portion for determining the origin of the source of received information, and a “then” portion for specifying handling of the received information.

11. A system as in claim 10 wherein the then portion includes a reference to the stored program.

12. A system as in claim 11 wherein the then portion further includes a parameter to be supplied to the stored program.

13. A system as in claim 11 wherein the then portion further includes a location at which the stored program is to be executed.

14. A system as in claim 1 wherein the stored program is used to manage a network.

15. A method for providing information to a stored program executing on a computer coupled to an output port of a device in a network, the method comprising:
providing the information to the network in a format which includes payload information and address information to direct the payload information to the device;
in the device, storing a flow control table which has entries, each entry including source addresses representative of at least one source of information arriving at the device, destination addresses representative of at least one of the destinations to which the information arriving at the device is to be sent, and action information for each destination address, and the payload information is sent by the device to the destination referred to by the destination address; and
wherein the action information in the flow control table includes at least one program reference, and when the computer receives the payload information associated with that entry in the flow control table, the computer uses the payload information in execution of the stored program.

16. A method as in claim 15 wherein the action information includes default information used to control information which does not otherwise have an entry in the flow control table.

17. A method as in claim 15 further including a step of using the computer to control the switching system.

18. A method as in claim 17 wherein the computer is used to control a network.

19. A device adapted for connection to a network, the device for providing information to a stored program executing on a computer coupled to the device, the device comprising:
at least one input port for receiving packets of information from a source coupled to the network, at least some of which packets individually include a payload and a header having an address;
at least one output port for providing the packets of information from the source to a destination, the computer being coupled to receive the packets of information addressed to the computer;
a flow control table for storing at least the headers of the packets of information, which header includes:
a source address representative of at least one source of the packet arriving at the input port;
a destination addresses indicative of at least one destination to which the packet is to be sent from the output port; and
action information for that packet, the action information including at least one reference to the stored program executing on the computer; and
wherein based upon the action information, information the payload is used in execution of the stored program.

20. A device as in claim 19 wherein the source comprises a source of information coupled to the network.

21. A device as in claim 20 wherein the computer is directly connected to the output port.

22. A device as in claim 19 wherein the action information includes default priority information used to control information which does not otherwise have an entry in the flow control table.

23. A device as in claim 19 wherein the device includes a switch for switching information based on the destination addresses, and a controller coupled to the switch for storing the flow control table and controlling the switch in response thereto.

24. A device as in claim 23 wherein the switch comprises a router.

25. A device as in claim 24 wherein the controller is itself controlled by a computer.

26. A device as in claim 23 wherein the controller manages the flow control table using an applications program interface.

27. A device as in claim system as in claim 23 wherein the action information in the flow control table is established by an applications program interface which communicates with the device.

28. A device as in claim 27 wherein the applications program interface employs an argument which includes an “if” portion for determining the origin of the source of received information, and a “then” portion for specifying handling of the received information.

29. A device as in claim 28 wherein the “then” portion includes a reference to the stored program.

30. A device as in claim 29 wherein the “then” portion further includes a parameter to be supplied to the stored program.

31. A device as in claim 30 wherein the “then” portion further includes location at which the stored program is to be executed.

32. A device as in claim 19 wherein the stored program is used to manage the network.
